(19) United States
(12) Patent Application Publication
(10) Pub. No.: US 2010/0078839 A1
(43) Pub. Date: Apr. 1, 2010

(54) Pitch densification of carbon fiber preforms

(75) Inventors: Allen H. Simpson, Buchanan, MI (US); Slawomir T. Fryska, Granger, IN (US); Mark L. La Forest, Granger, IN (US)

Correspondence Address: HONEYWELL/BSKB;PATENT SERVICES, 101 COLUMBIA ROAD, P.O. BOX 2245, MORRISTOWN, NJ, 07962-2245, US

(73) Assignee: HONEYWELL INTERNATIONAL INC.

(21) Appl. No.: 11/471,602

(22) Filed: Jun. 21, 2006

Related U.S. Application Data
(60) Provisional application No. 60/693,062, filed on Jun. 23, 2005.

(51) Int. Cl. C01B 31/00

(52) U.S. Cl. 264/29.5

(57) ABSTRACT

A pitch densification process which is widely applicable in the densification of carbon fiber preforms and stabilized pitch fiber preforms. The process includes: (a.) introducing liquid pitch into a fibrous carbon preform; (b.) carbonizing the pitch-impregnated preform by heating it in the absence of oxidizing agents; and subsequently (c.) further densifying the carbonized pitch-impregnated preform. The pitch used for densification may be coal tar pitch, petroleum pitch, or synthetic pitch. The softening point of the pitch will normally range from 100° C. to 340° C., depending upon the properties to be imparted to the finished product.

This application claims the benefit under 35 USC §119 of provisional application Ser. No. 60/693,062, filed Jun. 23, 2005. The entire contents of Ser. No. 60/693,062 is expressly incorporated by reference herein.

### FIELD OF THE INVENTION

This invention relates to the manufacture of carbon-carbon composite materials. More specifically, this invention relates to the production of carbon-carbon composite performs that are especially useful in the manufacture of aircraft landing system brake discs.

### BACKGROUND OF THE INVENTION

Conventional methods of densifying carbon fiber preforms for use as friction materials, especially those involving chemical vapor deposition (CVD), are costly and require expensive capital equipment. Also, such processes are time consuming. Achieving material final densities in excess of 1.7 gr/cc while controlling material characteristics with such processes is very difficult. The present invention can replace all or a major part of CVD processing in the densification of carbon-carbon fiber-based composites by processing which includes pitch impregnation followed by carbonization, optional heat treatment, and optional machining.

The present application employs the acronym “CVD” for the sake of convenience. Those skilled in the art are aware that processes similar to CVD processes, referred to as “chemical vapor infiltration” or “CVI” processes, can be used interchangeably with CVD processes. Therefore references herein to “CVD” processing should be understood to apply equally to “CVI” processing.

US 2004/0168612 A1 discloses a method of making a saturated aircraft brake preform by placing a carbon fiber preform under a vacuum, heating the carbon fiber preform, introducing coal tar pitch having a softening point of 160-240° C. into the carbon fiber preform, pressurizing the coal tar pitch-saturated carbon fiber preform with nitrogen, cooling the saturated carbon fiber preform, and processing the saturated carbon fiber preform by chemical vapor infiltration (CVI). US 2004/0168612 A1 does not teach carbonizing the pitch in the preform prior to the CVI step.

### SUMMARY OF THE INVENTION

The present invention provides a pitch densification process that is widely applicable in the densification of carbon fiber preforms and stabilized pitch fiber preforms. The process of this invention includes the steps of: (a.) introducing liquid pitch into a fibrous carbon preform; (b.) carbonizing the pitch-impregnated preform by heating it in the absence of oxidizing agents; and subsequently (c.) further densifying the carbonized pitch-impregnated preform. The pitch used for densification may be coal tar pitch, petroleum pitch, or synthetic pitch. The softening point of the pitch will normally range from 100° C. to 340° C., depending upon the properties to be imparted to the finished product. One useful pitch is Koppers Coal Tar Pitch, with a melting point of 180° C.

Another aspect of the present invention is a process for improving the economics of manufacturing a carbon-carbon composite having a density of more than 1.7 g/cc. This process is based upon replacing from 50% to 100% of CVD processing in the densification of carbon-carbon fiber-based composites by processing which includes pitch impregnation as described herein followed by carbonization.

### DETAILED DESCRIPTION OF THE INVENTION

In accordance with this invention, the pitch may be heated and introduced into the preform. This may be accomplished by a number of different methods. One such method involves preheating the preform under a vacuum to a point approximately 100° C. above the melting point of the pitch. Then liquid phase pitch is introduced into the vessel containing the carbon fiber preform. Non-reactive gas is introduced into the vessel containing the preform and pitch at a pressure up to 300 p.s.i. The pressure forces the pitch into the pores of the preform. The pressure in the vessel is later released and the excess pitch in the vessel is drained away. Alternatively, pitch impregnation may be accomplished by other methods.

The preform is permitted to cool and is then removed from the vessel. The preform is then carbonized by heating the preform in the absence of oxidizing agents to a temperature above 500° C., typically around 750° C. Optionally, in order to further open the porosity and modify the friction and wear characteristics, the preform may be heat treated separately or as part of a higher temperature carbonization cycle, to temperatures from as low as 600° C. to as high as 2950° C. Optionally, the preforms may then be scraped and/or machined to remove the excess carbonized pitch from the surface of the now partially densified preform.

At this point, a carbon fiber preform which has an initial density of about 0.50 gr/cc will now have a density of about 1.0 gr/cc. Carbon-carbon composites for use as aircraft friction materials typically require densities of 1.7 gr/cc or higher. This may be achieved by completing densification through two or more CVD cycles. More preferably, such higher densities may be achieved by repeating the previous steps of pitch impregnation, carbonization, optional heat treatment, and optional carbonized pitch removal. After about four additional cycles (and depending upon the pitches employed), the material density will be near or above 1.7 gr/cc. This approach eliminates the need for CVD processing. As yet another alternative, and in order to modify friction and wear characteristics and material strength, fewer pitch impregnation cycles may be used, followed by a single CVD cycle to achieve the desired material density.

### EXAMPLES

### Example 1

A Boeing 777 aircraft brake preform made by Honeywell International is placed into a pressure vessel and heated to 320 degrees Celsius. The pressure inside the vessel is reduced to below 10 Torr. The vessel is then flooded with molten coal tar pitch having a softening point of 180 degrees Celsius, completely immersing the preform. The pressure is increased to 75 psi and held for 6 hours. The vessel is opened and the preform removed and placed into a carbonization furnace, carbonized to 900 degrees Celsius and subsequently heat treated to 1600 degrees Celsius. The heat treated preform is then ground on all surfaces to remove excess carbonized pitch and better open the pores in the carbonized pitched for further densification. After a single densification, carbonization, and heat treatment the density of the composite is 1.05 grams/cc.

The vacuum, infiltration, carbonization and heat treatment is repeated for a second time. Again the preform is ground on all sides to remove excess carbonized pitch. The density is 1.37 grams/cc.

The vacuum, infiltration, carbonization and heat treatment is repeated for a third time and again the preform is ground on all sides to remove excess carbonized pitch. The density is 1.56 grams/cc.

The vacuum, infiltration, carbonization and heat treatment is repeated yet again, and again the preform is ground on all sides to remove excess carbonized pitch. After the fourth round of processing is complete, the density of the part 1.71 grams/cc

### Example 2

A Boeing 777 aircraft brake preform made by Honeywell International is placed into a pressure vessel and heated to 320 degrees Celsius. The pressure inside the vessel is reduced to below 10 Torr. The vessel is then flooded with molten coal tar pitch having a softening point of 180 degrees Celsius, completely immersing the preform. The pressure is increased to 75 psi and held for 6 hours. The vessel is opened and the preform removed and placed into a carbonization furnace, carbonized to 900 degrees Celsius and subsequently heat treated to 1600 degrees Celsius. The heat treated preform is then ground on all surfaces to remove excess carbonized pitch and better open the pores in the carbonized pitched for further densification. After a single densification, carbonization, and heat treatment the density of the composite is 1.05 grams/ cc.

The vacuum, infiltration, carbonization and heat treatment is repeated for a second time. Again the preform is ground on all sides to remove excess carbonized pitch. The density is 1.37 grams/cc.

The vacuum, infiltration, carbonization and heat treatment is repeated for a third time and again the preform is ground on all sides to remove excess carbonized pitch. The density is 1.56 grams/cc.

The preform is placed into a CVD furnace where it is heated to about 1000 degrees Celsius and infiltrated with hydrocarbon gases at a pressure below 30 Torr for about two weeks. After the CVD cycle is complete, the density of this preform is 1.73 grams/cc.

### Analysis.

Taken together, Examples 1 and 2 demonstrate that processing in accordance with the present invention can provide excellent carbon-carbon composite preform densities with no (Example 1) or relatively little (Example 2) CVD processing.

The present invention has been described herein in terms of preferred embodiments. However, obvious modifications and additions to the invention will become apparent to those skilled in the relevant arts upon a reading and understanding of the foregoing description. It is intended that all such modifications and additions form a part of the present invention to the extent that they fall within the scope of the several claims appended hereto.

1. A process for preparing a carbon-carbon composite aircraft brake disc having a density of more than 1.7 g/cc, which process comprises the steps of:
providing a fibrous carbon aircraft brake disc preform
placing said brake preform into a pressure vessel,
pre-heating said brake preform and said pressure vessel to 320° C.,
reducing pressure in the pressure vessel to below 300 Torr,
then flooding the vessel with molten coal tar pitch or mesophase pitch, said pitch having a softening point of about 180° C., to completely immerse the preform, and
increasing pressure in the pressure vessel to 75 psi and holding it at that level for 6 hours;
carbonizing the pitch-impregnated preform by heating it in the absence of oxidizing agents to a temperature of from 500° C. to about 750° C.;
heat treating the carbonized pitch-impregnated preform at a temperature of from 600° C. to 2950° C.;
mechanically removing carbonized pitch from the surface of the carbonized pitch-impregnated preform; and
repeating the vacuum, infiltration, carbonization, heat treatment, and mechanical pitch removal cycle for a total of four times, thereby producing a carbon-carbon composite preform having a density of more than 1.7 g/cc,
wherein said preform is not subjected to CVD processing at any stage of its processing.

2. (canceled)

3. The process of claim 1, wherein, subsequent to introduction of the liquid pitch into the fibrous carbon preform, a non-reactive gas is introduced into a vessel containing the preform and pitch at a pressure up to 300 p.s.i.

4. The method of claim 3, wherein said non-reactive gas is introduced into the vessel containing the preform and pitch at a pressure of 50 p.s.i.

5.-13. (canceled)

14. A process for preparing a carbon-carbon composite aircraft brake disc having a density of more than 1.7 g/cc, which process comprises the steps of:
providing an fibrous carbon aircraft brake disc preform,
placing said brake preform into a pressure vessel,
pre-heating said brake preform and said pressure vessel to 320° C.,
reducing pressure in the pressure vessel to below 300 Torr,
then flooding the vessel with molten coal tar pitch or mesophase pitch, said pitch having a softening point of about 180° C., to completely immerse the preform, and
increasing pressure in the pressure vessel to 75 psi and holding it at that level for 6 hours;
carbonizing the pitch-impregnated preform by heating it in the absence of oxidizing agents to a temperature of from 500° C. to about 750° C.;
heat treating the carbonized pitch-impregnated preform at a temperature of 1600° C.;
mechanically removing carbonized pitch from the surface of the carbonized pitch-impregnated preform; and
repeating the vacuum, infiltration, carbonization, heat treatment, and mechanical pitch removal cycle for a total of four times, thereby producing a carbon-carbon composite preform having a density of more than 1.7 g/cc,
wherein said preform is not subjected to CVD processing at any stage of its processing.

15. A process for preparing a carbon-carbon composite having a density of more than 1.7 g/cc, which process comprises the steps of:
(i.) introducing liquid phase pitch into a fibrous carbon preform, including: placing a brake preform into a pressure vessel, heating said brake preform and said pressure vessel to 320° C., and reducing the pressure in the pressure vessel to below 10 Torr; flooding the vessel with molten coal tar pitch or mesophase pitch, said pitch having a softening point of 180° C., completely immersing the preform; and increasing the pressure in the pressure vessel to 75 psi and holding it at that level for 6 hours;
(ii.) carbonizing the pitch-impregnated preform by heating it in the absence of oxidizing agents;
(iii.) heat treating the carbonized pitch-impregnated preform at a temperature of from 600° C. to 2950° C.;
(iv.) mechanically removing carbonized pitch from the surface of the carbonized pitch-impregnated preform;
(v.) repeating the preceding steps for a total of three times; and
(vi.) placing the preform into a CVD furnace and heating it therein to about 1000° C. and infiltrating it with hydrocarbon gases at a pressure below 30 Torr for about two weeks, thereby producing a carbon-carbon composite having a density greater than 1.7 grams/cc.
